(19) United States
(12) Patent Application Publication
(10) Pub. No.: US 2016/0239923 A1
(43) Pub. Date: Aug. 18, 2016

(54) Insurance System and Method of Use

(71) Applicant: IAN Group LLC, Amarillo, TX (US)

(72) Inventor: Trent Phillips, Amarillo, TX (US)

(21) Appl. No.: 15/047,599

(22) Filed: Feb. 18, 2016

Related U.S. Application Data
(60) Provisional application No. 62/117,766, filed on Feb. 18, 2015.

(51) Int. Cl. G06Q 40/08

(52) U.S. Cl. CPC G06Q 40/08

(57) ABSTRACT

An apparatus, comprising: at least one memory including computer program code. At least one processor, wherein the at least one memory and the computer program code are configured to, with the at least one processor, cause the apparatus at least to receive a claims event from an insured, calculating a one or more claim requirement recommendations based on the claims event and an E&O index table stored in the at least one memory, and assessing the validity of the claims event based on the comparison of the claims event to the one or more claim requirement recommendations.

### CROSS-REFERENCE TO RELATED APPLICATIONS

This application claims benefit to U.S. Patent Application No. 62/117,766 which was filed one year prior to this filing on 2015 Feb. 18, that application is hereby incorporated by reference.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

This disclosure relates generally to an Insurance System and Method of Use. Examples of similar disclosures can be found at US 20110131137 A1, U.S. Pat. No. 8,626,538 B1, US 20140143133 A1, WO 2012142347 A1, US 20140278573 A1, U.S. Pat. No. 7,966,200 B1, US 20090048877 A1, U.S. Pat. No. 8,442,847 B1, and U.S. Pat. No. 8,494,882 B1. However, none of the known inventions and patents, taken either singularly or in combination, is seen to describe the instant disclosure as claimed. Accordingly, an improved Insurance System and Method of Use would be advantageous.

One objective of the insurance product creation system is to provide customer and value-added service to said insured 602 as well as said agency 604 in the event of an insurance claim. In one embodiment, the agency 604 and its affiliated industries have has become limited in the “claim support” from the carriers' standpoint. The carrier 606 has set a boundary between said agency 604 and said insured 602. The carrier 606 wants to handle the claim in the best interest of the carrier 606, not the policyholder or the agency 604. The agent/agency 604 can sell an insurance policy, but when there is a claim, they cannot service it. The servicing of the claim is done at the discretion of the carrier 606 and their representative (said adjuster 608). If there is a dispute within the settlement, the policyholder (said insured 602) does not have anyone to advocate on their behalf. Unless the adjuster 608 carries the specific adjuster's license (required by various licensing agencies such as the Texas Department of Insurance), the adjuster 608 cannot lawfully negotiate, advocate, and/or settle a claim. This limits the adjuster 608's involvement. The solution is that the insurance agency 604 use said insurance product creation system 100 to advocate on behalf of the agency 604 as well as the policyholder to fight for a fair and reasonable settlement.

Another problem is the “human factor” of settling coverage for a particular one among said insured 602, being it business or personal insurance. In one embodiment, said insurance product creation system 100 allows the guessing work to be at a minimum, as the system can determine the type of coverage needed and the policy that will provide this coverage.

Said insurance product creation system 100 can provide the value-added services to independent insurance agencies: claims negotiations; claim settlements; verification of claim coverage; agency/agent education on the claims process; Insurance to Value evaluations; strategic evaluations for clientele business; risk training for avoidance of E&O claims; legal issues; IAN certification given to agencies as well as management; agency adjusting firms.

Said insurance product creation system 100 can be used for separate claims tracking software to determine the needs, the particular coverage, the settlement, and the follow-up. This will allow the policyholder to move through the claims process with ease, knowing the timeframe will be met as required by the carrier 606.

Coverage will be used as provided by the agency 604, and the settlement will be made in accordance with the policy provisions. The follow-up will be set in a timely fashion for the agency 604 to not only have a “touch” but a possibility for up-sale. In one embodiment, said insurance product creation system 100 program allows the adjuster 608 and/or the advocate (said adjuster 608) to determine coverage by the insurance product creation system 100 stating where the cover is within the policy and if the insured 602 has this particular coverage.

The insurance product creation system 100, however, does not determine the financial settlement, only the coverage.

As is known in the art, many insurance agencies do have a low paid employee that will turn in the claim and then will close the claim once the carrier 606 states their decision.

### BRIEF SUMMARY OF THE INVENTION

An apparatus, comprising: at least one memory including computer program code. At least one processor, wherein the at least one memory and the computer program code are configured to, with the at least one processor, cause the apparatus at least to receive a claims event from an insured, calculating a one or more claim requirement recommendations based on the claims event and an E&O index table stored in the at least one memory, and assessing the validity of the claims event based on the comparison of the claims event to the one or more claim requirement recommendations.

An apparatus, comprising: at least one memory including computer program code. At least one processor, wherein the at least one memory and the computer program code are configured to, with the at least one processor, cause the apparatus at least to analyzing a policy offering to a client at a time of policy initiation by: categorizing a client into a known and risk profiles and generating a policy quote. Comparing the policy quote to a one or more data sources to determine completeness of the policy quote. Comparing the policy quote with previous events to determine likelihood of risk to the client associated with the policy quote.

A computer program product embodied on a non-transitory computer readable storage medium, the computer program product being encoded with instructions to control a processor to perform a process, the process comprising: receive a claims event from an insured, calculating a one or more claim requirement recommendations based on the claims event and an E&O index table stored in the at least one memory, and assessing the validity of the claims event based on the comparison of the claims event to the one or more claim requirement recommendations.

### BRIEF DESCRIPTION OF THE SEVERAL VIEWS OF THE DRAWING

FIG. 1 illustrates a first network configuration 101 of an insurance product creation system 100.

FIGS. 2A, 2B and 2C illustrate a perspective overview of a mobile phone 201a, a personal computer 201b and a tablet 201c.

FIGS. 3A, 3B and 3C illustrate an address space 302 within said one or more computers, an address space 302a and an address space 302d.

FIGS. 4A and 4B illustrate two embodiments for collecting and storing data with said insurance product creation system 100; a first embodiment with a flow diagram between said first computer 102a and said server 108, and a second embodiment comprising of just said first computer 102a.

FIGS. 5A and 5B illustrate two examples of a flow diagram between said memory 306a and said memory 306d.

FIG. 6 illustrates a flow chart 600.

FIG. 7 illustrates a schematic 700 of said insurance product creation system 100.

FIG. 8 illustrates a policy acquisition procedure 800.

FIG. 9 illustrates a claim event procedure 900.

FIG. 10 illustrates a claim analysis procedure 1000.

FIG. 11 illustrates a policy offering review procedure 1100.

### DETAILED DESCRIPTION OF THE INVENTION

Described herein is an insurance system and method of use. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

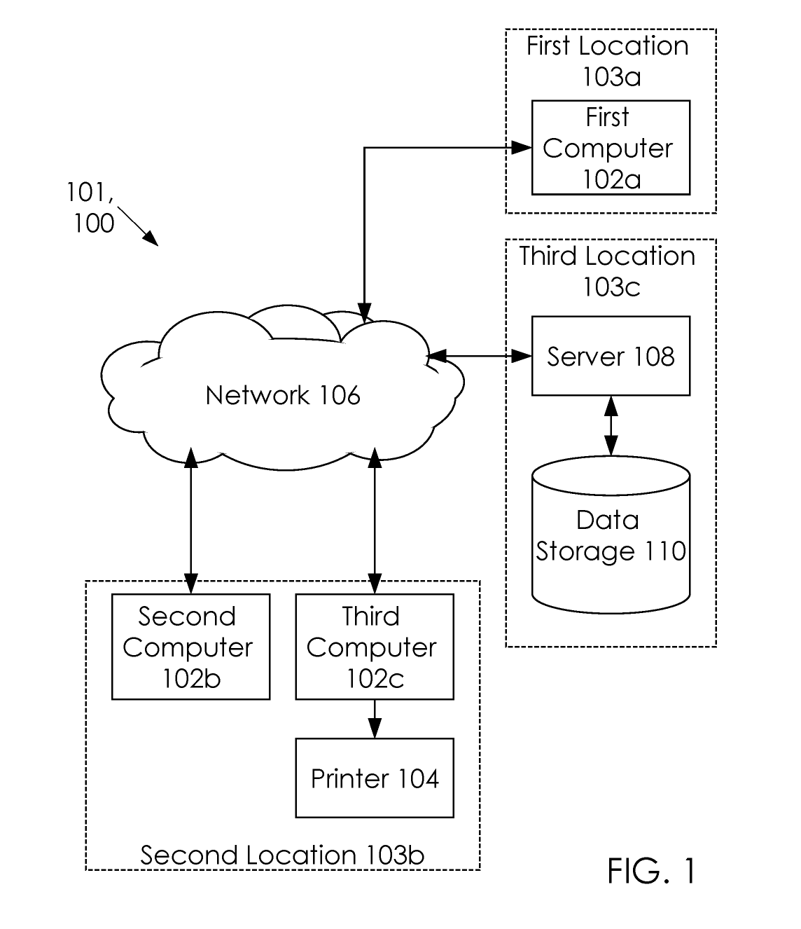

FIG. 1 illustrates a first network configuration 101 of an insurance product creation system 100.

In one embodiment, said insurance product creation system 100 can comprise a one or more computers at a one or more locations. In one embodiment, said one or more computers can comprise a first computer 102a, a second computer 102b and a third computer 102c. In one embodiment, said one or more locations can comprise a first location 103a, a second location 103b and a third location 103c. In one embodiment, said first location can comprise a field location. In one embodiment, said one or more computers can communicate on a network 106, which can connect to a one or more servers (such as a server 108). In one embodiment, a printer 104 can be hardwired to said first computer 102a (not illustrated here), or said printer 104 can connect to one of said one or more computers (such as said third computer 102c, illustrated) via network 106.

Said network 106 can be a local area network (LAN), a wide area network (WAN), a piconet, or a combination of LANs, WANs, or piconets. One illustrative LAN is a network within a single business. One illustrative WAN is the Internet.

In one embodiment, said server 108 represents at least one, but can be many servers, each connected to said network 106. Said server 108 can connect to a data storage 110. Said data storage 110 can connect directly to said server 108, as shown in FIG. 1, or may exist remotely on said network 106. In one embodiment, said data storage 110 can comprise any suitable long-term or persistent storage device and, further, may be separate devices or the same device and may be collocated or distributed (interconnected via any suitable communications network).

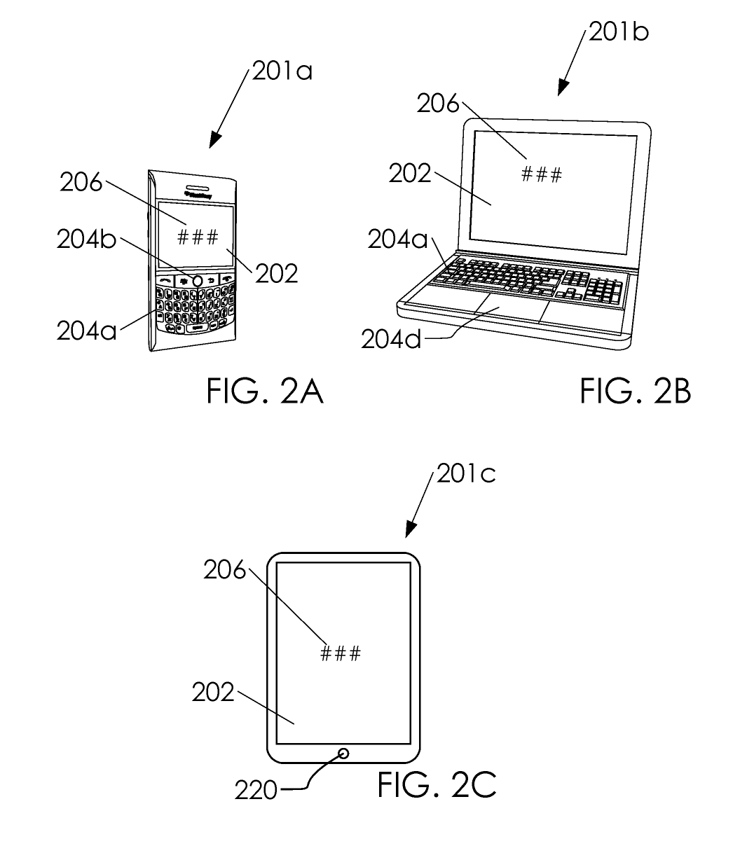

FIGS. 2A, 2B and 2C illustrate a perspective overview of a mobile phone 201a, a personal computer 201b and a tablet 201c.

In the last several years, the useful definition of a computer has become more broadly understood to include mobile phones, tablet computers, laptops, desktops, and similar. For example, Microsoft®, have attempted to merge devices such as a tablet computer and a laptop computer with the release of “Windows® 8”. In one embodiment, said one or more computers each can include, but is not limited to, a laptop (such as said personal computer 201b), desktop, workstation, server, mainframe, terminal, a tablet (such as said tablet 201c), a phone (such as said mobile phone 201a), and/or similar. Despite different form-factors, said one or more computers can have similar basic hardware, such as a screen 202 and a one or more input devices (such as a keyboard 204a, a trackball 204b, a one or more cameras 204c, a wireless—such as RFID—reader, a track pad 204d, and/or a home button 220). In one embodiment, said screen 202 can comprise a touch screen. In one embodiment, said track pad 204d can function similarly to a computer mouse as is known in the art. In one embodiment, said tablet 201c and/or said personal computer 201b can comprise a Microsoft® Windows® branded device, an Apple® branded device, or similar. In one embodiment, said tablet 201c can be an X86 type processor or an ARM type processor, as is known in the art.

Said insurance product creation system 100 can comprise a data 206. In one embodiment, said data 206 can comprise data related to financial transactions.

In one embodiment, said one or more computers can be used to input and view said data 206. In one embodiment, said data 206 can be input into said one or more computers by taking pictures with one of said one or more camera 204c, by typing in information with said keyboard 204a, or by using gestures on said screen 202 (where said screen 202 is a touch screen). Many other data entry means for devices similar to said one or more computers are well known and herein also possible with data 206. In one embodiment, said first computer 102a can comprise an iPhone®, a BlackBerry®, a smartphone, or similar. In one embodiment, one or more computers can comprise a laptop computer, a desktop computer, or similar.

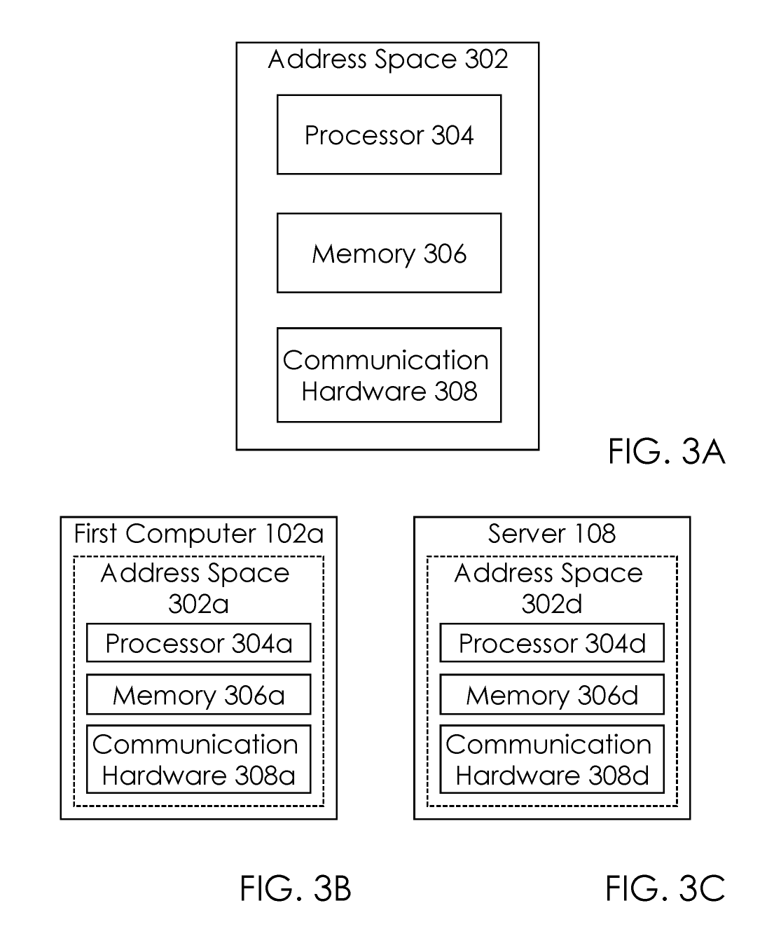

FIGS. 3A, 3B and 3C illustrate an address space 302 within said one or more computers, an address space 302a and an address space 302d.

Each among said one or more computers and said server 108 can comprise an embodiment of address space 302. In one embodiment, said address space 302 can comprise a processor 304, a memory 306, and a communication hardware 308. In one embodiment, said processor 304 can comprise a plurality of processors, said memory 306 can comprise a plurality of memory modules, and said communication hardware 308 can comprise a plurality of communication hardware components. In one embodiment, said data 206 can be sent to said processor 304; wherein, said processor 304 can perform processes on said data 206 according to an application stored in said memory 306, as discussed further below. Said processes can include storing said data 206 into said memory 306, verifying said data 206 conforms to a one or more preset standards, or ensuring a required set among said required data 206 has been gathered for said data management system and method. In one embodiment, said data 206 can include data which said one or more computers can populate automatically, such as a date and a time, as well as data entered manually. Once a portion of gathering data has been performed said data 206 can be sent to said communication hardware 308 for communication over said network 106. Said communication hardware 308 can include a network transport processor for packetizing data, communication ports for wired communication, or an antenna for wireless communication. In one embodiment, said data 206 can be collected in one or more computers and delivered to said server 108 through said network 106.

In one embodiment, said first computer 102a can comprise said address space 302a, a processor 304a, a memory 306a, and a communication hardware 308a. Likewise, in one embodiment, said server 108 can comprise said address space 302d, a processor 304d, a memory 306d, and a communication hardware 308d.

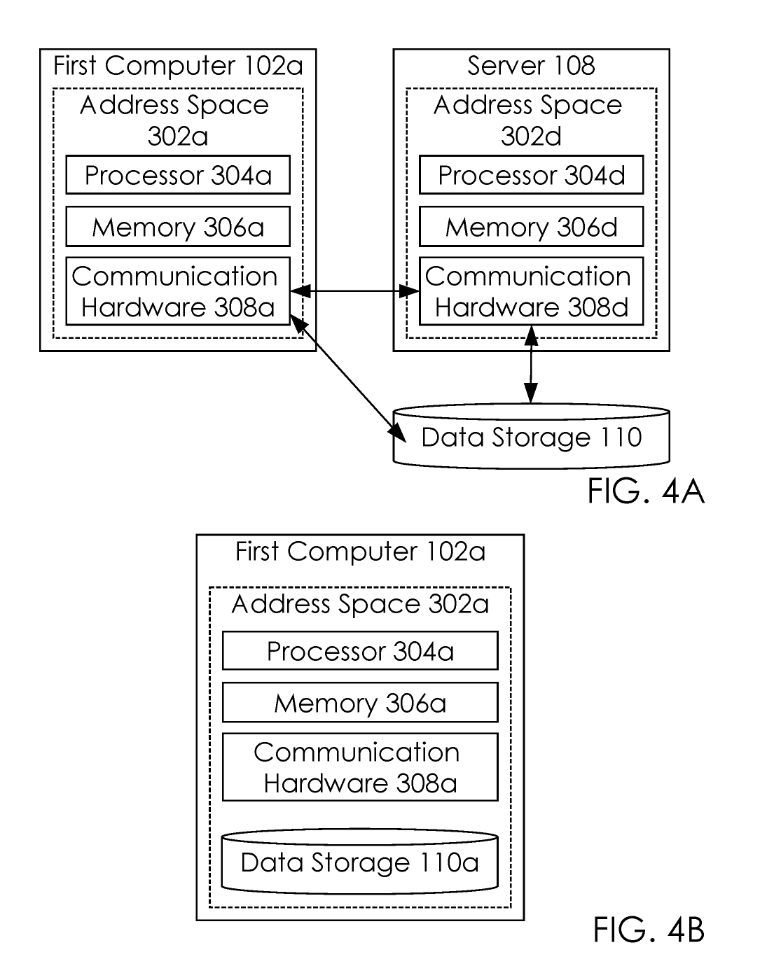

FIGS. 4A and 4B illustrate two embodiments for collecting and storing data with said insurance product creation system 100; a first embodiment with a flow diagram between said first computer 102a and said server 108, and a second embodiment comprising of just said first computer 102a.

In the first embodiment, said communication hardware 308a and said communication hardware 308d can send and receive data to and from one another and or can communicate with said data storage 110 across said network 106. Likewise, in the second embodiment, data storage 110 can be embedded inside of said one or more computers as a data storage 110a, which may speed up data communications by said insurance product creation system 100. In another embodiment, said data can be stored temporarily on said data storage 110a and later moved to said data storage 110 for backup and sharing purposes.

As illustrated in FIG. 4A, in one embodiment, said server 108 can comprise a third party data storage and hosting provider or privately managed as well.

As illustrated in FIG. 4B, said data storage 110 can be located on said first computer 102a, here labeled as said data storage 110a. Thus, said first computer 102a can operate without a data connection out to said server 108 while performing said system and method for field capture of data.

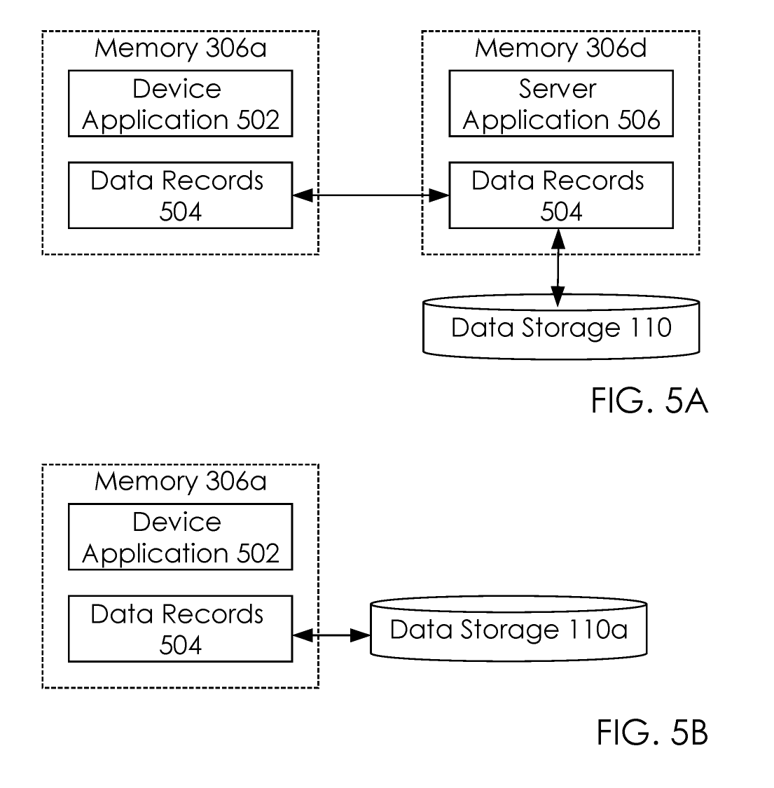

FIGS. 5A and 5B illustrate two examples of a flow diagram between said memory 306a and said memory 306d.

As illustrated in FIG. 5A, in one embodiment, said insurance product creation system 100 can process said data 206 on said first computer 102a and/or said server 108. For example, in one embodiment, said memory 306a can comprise a device application 502 capable of generating a data records 504 from user inputs or, otherwise, processing said data records 504 delivered to said device application 502 from said data storage 110. In one embodiment, said data records 504 can be transferred between said device application 502 on said memory 306a of said first computer 102a and a server application 506 in said memory 306d of said server 108. In one embodiment, said server 108 can be useful for processing said data 206, as is known in the art. As illustrated in FIG. 5B, in another embodiment, said server 108 can be removed from the flow diagram entirely as said memory 306a is capable of processing said data records 504 and/or said data 206 without the assistance of said server 108.

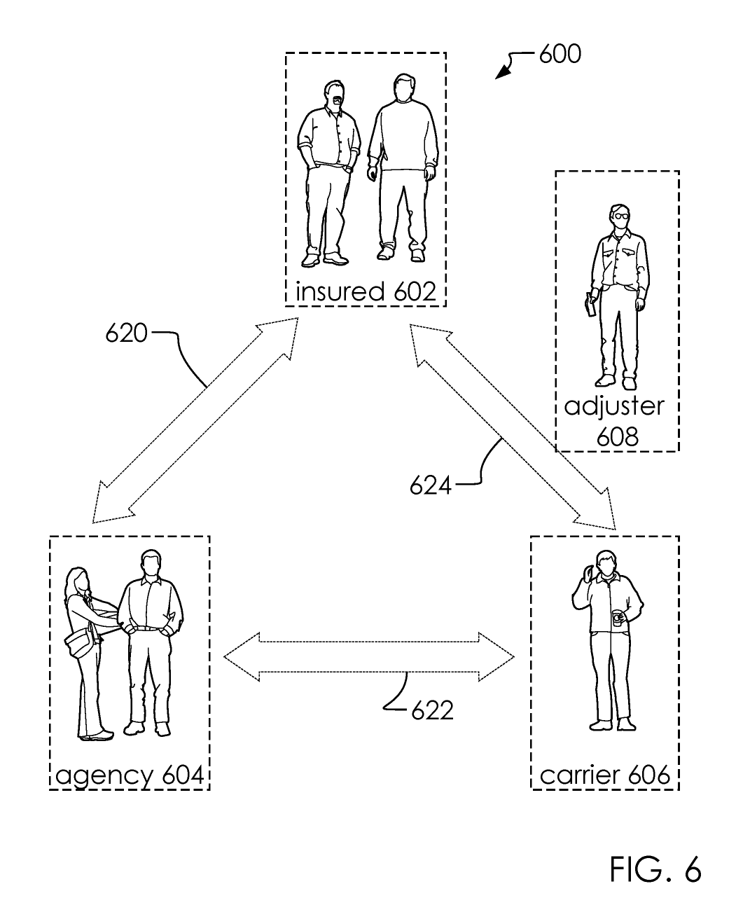

FIG. 6 illustrates a flow chart 600.

In one embodiment, said insurance product creation system 100 negotiates rights between an insured 602, an agency 604 and a carrier 606. In one embodiment, said insured 602 can discuss an insurance acquisition 620 with said agency 604. In one embodiment, said agency 604 can discuss a policy acquisition 622 with said carrier 606. In one embodiment, said insured 602 can file a claim negotiation 624 with said carrier 606. In one embodiment, said adjuster 608 can negotiate said claim negotiation 624 between said insured 602 and said carrier 606.

The pain of any claim is that the insured 602 is at the mercy of the carrier 606 (insurance company) and the adjuster 608. They rely on the carrier 606 to provide proper and fair settlement. In today's environment, policyholders or the insured 602 are extremely leery of insurance companies in general. The agency 604 that sold the policy to the insured 602 is at the mercy of the carrier 606 during a claim because, as is the case in certain US states, legislation requires a license to negotiate and settle any insurance-related claim.

Most agencies do not have an employee who holds such a license, so by default, they are reliant on the carrier 606 and their adjuster 608. When there is an issue with a claim brought up by the agency 604's insured 602, the agency 604 has no other resource.

The insured 602 then has to turn to the expense of hiring attorneys to defend their case. The pain is that now the agency 604 is in fear of losing an account due to the lack of claims/customer service by the agency 604, which is “hand tied” due to state regulations.

To leverage the negotiating powers from the carrier 606 and its advocate (the adjuster 608), back to the policyholder. In one embodiment, said insurance product creation system 100 is used to serve the agency 604 and the insured 602 for proper claim settlement and education with honesty, integrity and efficiency.

In one embodiment, said insurance product creation system 100 is configured to negotiate and settle claims before attorneys get involved.

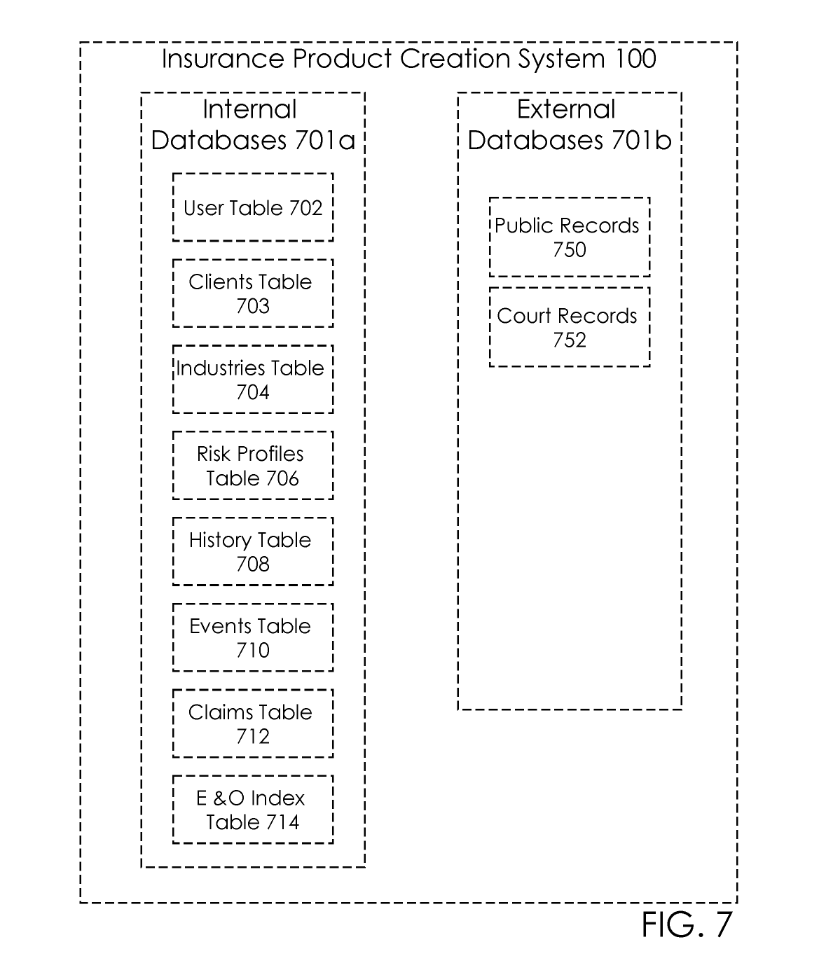

FIG. 7 illustrates a schematic 700 of said insurance product creation system 100.

In one embodiment, said insurance product creation system 100 can comprise an internal databases 701a and an external databases 701b. In one embodiment, said internal databases 701a can comprise a user table 702, a clients table 703, an industries table 704, a risk profiles table 706, a history table 708, an events table 710, a claims table 712, and an E&O index table 714. In one embodiment, said external databases 701b can comprise a public records 750 and a court records 752. In one embodiment, said user table 702 can comprise a list of users in said insurance product creation system 100. Said clients table 703 can comprise a list of clients for said agency 604 among said insured 602. In one embodiment, said industries table 704 can comprise a list of industries for which data is stored in said E&O index table 714. In one embodiment, said risk profiles table 706 can comprise a profile of risks for businesses categorized in said risk profiles table 706 or a list of risk profiles for parties in said user table 702. Said history table 708 can comprise a list of historical events relevant to said insurance product creation system 100. Said claims table 712 can comprise a list of claims filed by users, such as said insured 602, stored in said user table 702. In one embodiment, said E&O index table 714 can comprise an index of policy recommendations for different scenarios as characterized by the data in other tables in said internal databases 701a. In one embodiment, said public records 750 can comprise data which said insurance product creation system 100 indexes to populate said E&O index table 714. In one embodiment, said court records 752 can comprise a list of records of court cases and dispositions relevant to said industries table 704 and said user table 702.

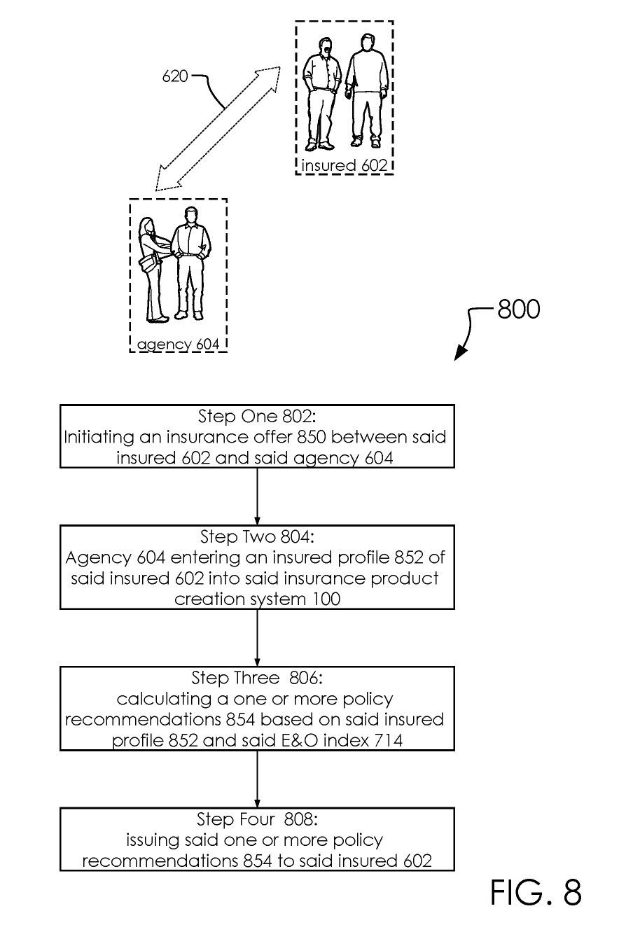

FIG. 8 illustrates a policy acquisition procedure 800.

In one embodiment, said policy acquisition procedure 800 can comprise a step one 802, a step two 804, a step three 806 and a step four 808. In one embodiment, said step one 802 can comprise initiating an insurance offer 850 between said insured 602 and said agency 604. Said step two 804 can comprise said agency 604 entering an insured profile 852 of said insured 602 into said insurance product creation system 100. Said step three 806 can comprise calculating a one or more policy recommendations 854 based on said insured profile 852 and said E&O index table 714. Said step four 808 can comprise issuing said one or more policy recommendations 854 to said insured 602 and/or said agency 604.

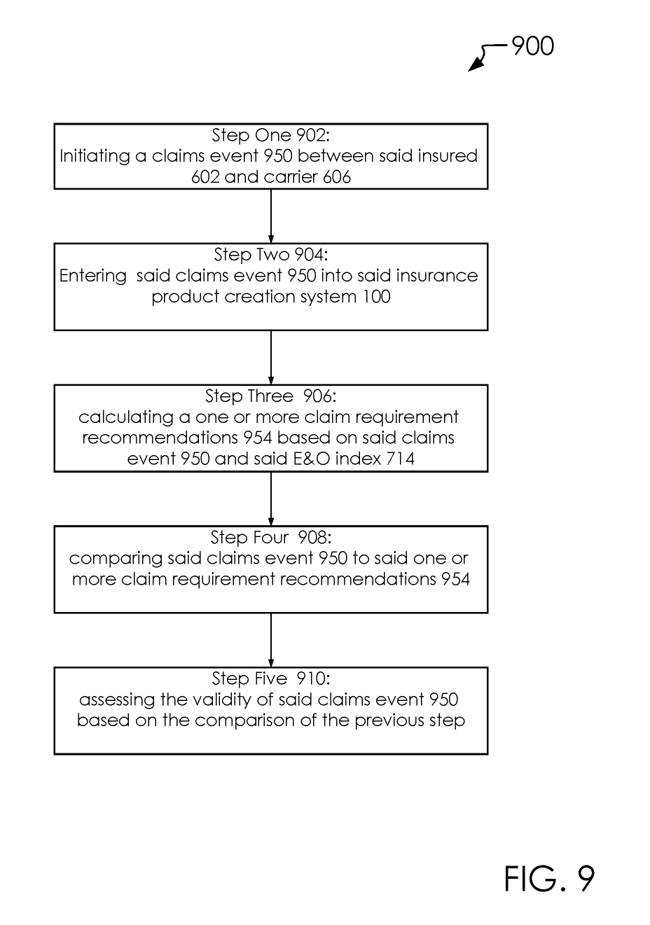

FIG. 9 illustrates a claim event procedure 900.

In one embodiment, said policy acquisition procedure 900 can comprise a step one 902, a step two 904, a step three 906, a step four 908 and a step five 910. Said step one 902 can comprise initiating a claims event 950 between said insured 602 and said carrier 606. Said step two 904 can comprise entering said claims event 950 into said insurance product creation system 100. Said step three 906 can comprise calculating a one or more claim requirement recommendations 954 based on said claims event 950 and said E&O index table 714. Said step four 908 can comprise comparing said claims event 950 to said one or more claim requirement recommendations 954. Said step five 910 can comprise assessing the validity of said claims event 950 based on the comparison of said step four 908.

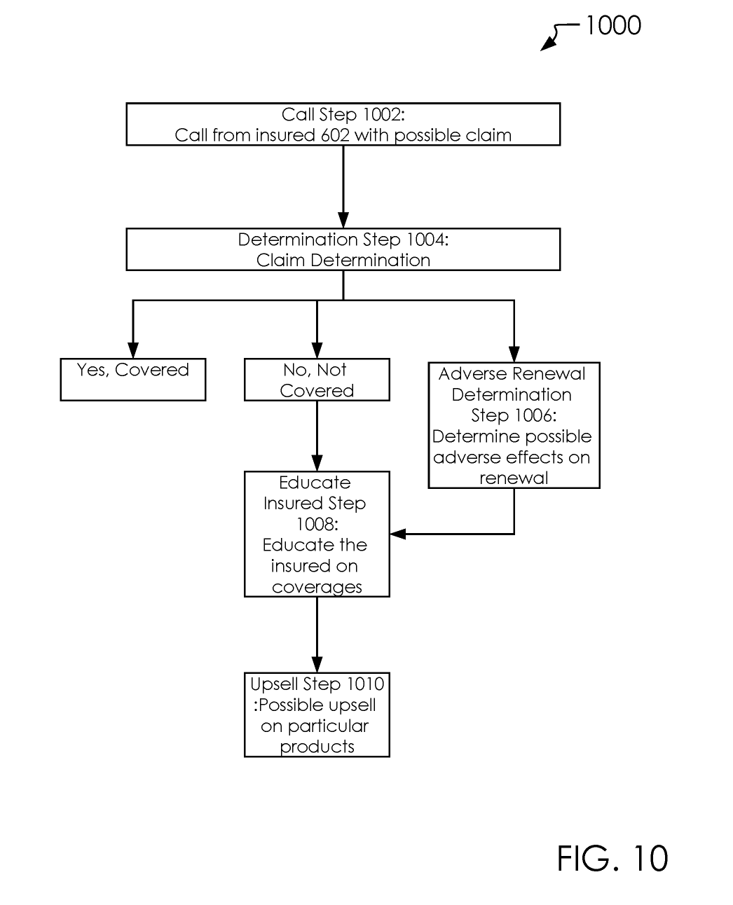

FIG. 10 illustrates a claim analysis procedure 1000.

In one embodiment, said claim analysis procedure 1000 can comprise a call step 1002, a determination step 1004, an adverse renewal determination step 1006, an educate insured step 1008, and an up sell step 1010.

The fundamental basis of claim analysis is to determine the coverage, the sequence of events, the pitfalls, the involved parties, and the questions that the carrier 606 will ask. Once this is determined and there is a meeting between the advocate and the insured 602, a claim will be turned in, providing these crucial answers. This will give all the information to the carrier 606 to assess the claim properly. This will allow the insured 602 to have the upper hand in the claims process.

Conversely, said insurance product creation system 100 will be able to use its claims support software to determine the coverage for argumentative support against the carrier 606 and their adjuster 608, or show this to the insured 602 and explain why it is not covered.

Most negotiations will be handled through the policyholder with the adjuster 608. This will allow open communications between the policyholder and the adjuster 608. The claims advocate associated with said insurance product creation system 100 will assess the initial offer, discuss this with the policyholder, and identify any other needs that need to be met. Once this determination is made, it will be addressed to the policyholder in a manner in which the policyholder is educated in the process and can speak the “insurance terms” to the adjuster 608 for matter of the settlement. The claims advocate in most cases will speak to the policyholder. Only in rare cases will the Insurance product creation system 100 claims advocate speak to the adjuster 608, and when this does happen, it will be in a role of the agency 604's representative and not as a third party.

Said educate insured step 1008 can comprise an important step. It is vitally important that the policyholder knows the claims process and what is about to be embarked upon. The initial meeting will lay out the normal claims process of the timeframe, questions asked, pitfalls to avoid, and settlement offers. This is important as the insured 602 is the one that has the contract with the carrier 606, as administered through the agency 604. The final settlement is between the policyholder and adjuster 608.

Insurance to Value “ITV” evaluations: This allows the insurance agency 604 to place a value on a particular property for replacement cost. Providing the correct ITV will not only protect the policyholder from a penalty of not insuring it correctly, but will also provide additional income to the agency 604. On average, agencies have an average ITV at 65%. Most carrier 606s, requires ITVs to be at least 80%, so there is a difference, on average, of 15% that is not being billed correctly, therefore causing loss of income to the agency 604 and jeopardizing the insured 602.

Preventative maintenance for Error and Omission (E&O) claims: A program can be set up with the insurance agency 604 to review complex and/or any particular policies to make sure claim scenarios have been reviewed and coverage has been offered to the policyholder. By offering Insurance product creation system 100's claims software to the agency 604, they will be able to write coverage correctly based on the information given from the policyholder.

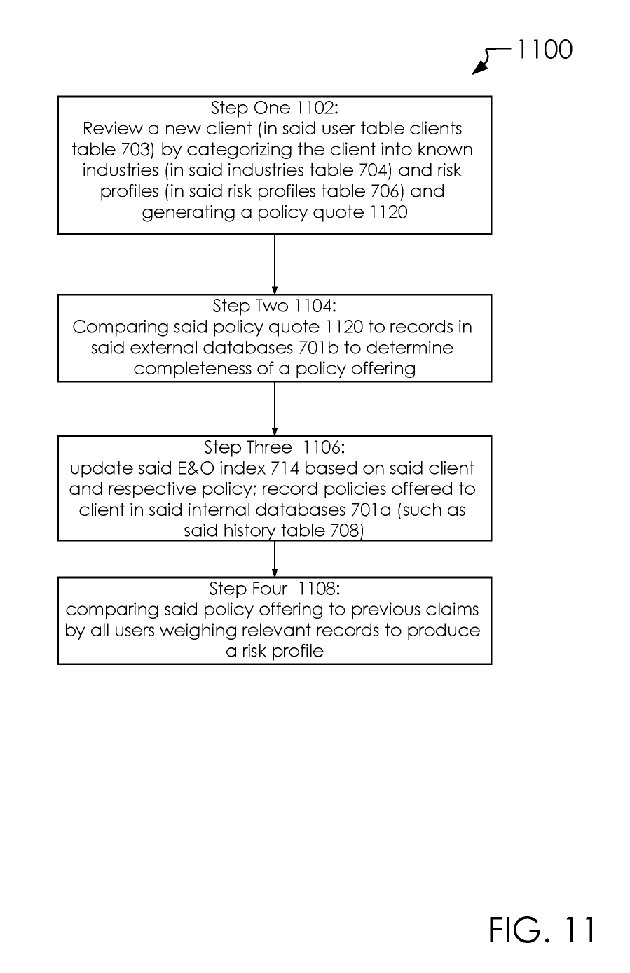

FIG. 11 illustrates a policy offering review procedure 1100.

In one embodiment, said policy offering review procedure 1100 can comprise a step one 1102, a step two 1104, a step three 1106 and a step four 1108.

In one embodiment, said policy offering review procedure 1100 can be used to analyze a policy offering to a client at a time of policy sign up. Said step one 1102 can comprise reviewing a new client (listed in said clients table 703) by categorizing that client into known industries (as listed in said industries table 704) and risk profiles (in said risk profiles table 706) and generating a policy quote 1120. In one embodiment, said step two 1104 can comprise comparing said policy quote 1120 to a one or more data sources in said external databases 701b (such as said public records 750, and/or said court records 752) to determine completeness of said policy quote 1120. In one embodiment, said insurance product creation system 100 can compare said policy quote 1120 with previous events such as law suits to determine likelihood of risk to the user underlying said policy quote 1120.

In one embodiment, said step three 1106 can comprise updating said E&O index table 714 based on said policy quote 1120; recording said policy quote 1120 into said internal databases 701a (such as said history table 708). Accordingly, said insurance product creation system 100 can protect insurance carriers by recording offerings made and rejected by the insured 602 and protect said insured 602 by showing likely risks that he may face.

In one embodiment, said step four 1108 can comprise comparing said policy quote 1120 to previous claims by all users and weighing relevant records to produce a risk profile for said user.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. An apparatus, comprising:
at least one memory including computer program code; and
at least one processor,
wherein the at least one memory and the computer program code are configured to, with the at least one processor, cause the apparatus at least to
receive a claims event from an insured,
calculating a one or more claim requirement recommendations based on said claims event and an E&O index table stored in said at least one memory, and
assessing the validity of said claims event based on the comparison of said claims event to said one or more claim requirement recommendations.

2. An apparatus, comprising:
at least one memory including computer program code; and
at least one processor,
wherein the at least one memory and the computer program code are configured to, with the at least one processor, cause the apparatus at least to analyzing a policy offering to a client at a time of policy initiation by:
categorizing a client into a known and risk profiles and generating a policy quote;
comparing said policy quote to a one or more data sources to determine completeness of said policy quote; and
comparing said policy quote with previous events to determine likelihood of risk to the client associated with said policy quote.

3. The apparatus of claim 2 wherein, said client is listed in a clients table in said at least one memory.

4. The apparatus of claim 2 wherein, said known industries are listed in an industries table in said at least one memory.

5. The apparatus of claim 2 wherein, said risk profiles are listed in a risk profiles table in said at least one memory.

6. The apparatus of claim 2 wherein
said one or more data sources comprise an external databases being outside of said apparatus.

7. The apparatus of claim 6 wherein
said external databases comprise a public records.

8. The apparatus of claim 6 wherein
said external databases comprise a court records.

9. The apparatus of claim 2 wherein
comparing said policy quote comprises comparing said policy quote with previous events such as law suits.

10. The apparatus of claim 2 further comprising
updating an E&O index table, in said at least one memory, based on said policy quote; and
recording said policy quote into said at least one memory.

11. The apparatus of claim 2 further comprising
protecting insurance carriers by recording offerings made and rejected by the client.

12. The apparatus of claim 2 further comprising
protecting said client by showing likely risks that he may face.

13. The apparatus of claim 2 further comprising
comparing said policy quote to previous claims by all users and weighing relevant records to produce a risk profile for said user.

14. A computer program product embodied on a non-transitory computer readable storage medium, the computer program product being encoded with instructions to control a processor to perform a process, the process comprising:
receive a claims event from an insured,
calculating a one or more claim requirement recommendations based on said claims event and an E&O index table stored in said at least one memory, and
assessing the validity of said claims event based on the comparison of said claims event to said one or more claim requirement recommendations.
